(19) United States
(12) Patent Application Publication
(10) Pub. No.: US 2018/0070361 A1
(43) Pub. Date: Mar. 8, 2018

(54) INTERFERENCE MITIGATION VIA SUBSPACE PROJECTION

(71) Applicant: QUALCOMM Incorporated, San Diego, CA (US)

(72) Inventors: Nicola Varanese, Nuremberg (DE); Louay Jalloul, San Jose, CA (US); Andrea Garavaglia, Nuremberg (DE)

(21) Appl. No.: 15/386,942

(22) Filed: Dec. 21, 2016

Related U.S. Application Data
(60) Provisional application No. 62/383,320, filed on Sep. 2, 2016.

(51) Int. Cl. H04W 72/08; H04L 12/24; H04L 25/02; H01Q 1/24; H01Q 9/04; H01Q 1/52

(52) U.S. Cl. CPC H04W 72/082; H04W 72/085; H04L 41/08; H01Q 1/521; H04L 25/0224; H01Q 1/243; H01Q 9/0442; H04L 41/12

(57) ABSTRACT

Methods, systems, and devices for wireless communication are described. A wireless device may transmit and receive signals using radio frequency (RF) chains associated with multiple radios configured for different radio access technologies (RATs). The wireless device may determine a signal of interest for each physical antenna of a set of RF chains associated with a RAT used to receive a desired signal. RF chains of the wireless device may be mapped to a virtual antenna configuration, which may be used to mitigate interference and subsequently process the desired receive signal. A determined interference channel may be used along with the determined signal of interest to map the RF chains to the virtual antenna configuration.

### CROSS REFERENCES

The present Application for Patent claims priority to U.S. Provisional Patent Application No. 62/383,320 by Varanese et al., entitled “INTERFERENCE MITIGATION VIA SUBSPACE PROJECTION,” filed Sep. 2, 2016, assigned to the assignee hereof, and which is hereby expressly incorporated by reference herein in its entirety.

### BACKGROUND

The following relates generally to wireless communication and more specifically to interference mitigation with subspace projection.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include access points (APs) that may communicate with one or more stations (STAs) or wireless devices. The AP may be coupled to a network, such as the Internet, and may enable a mobile device to communicate via the network (or communicate with other devices coupled to the access point). A wireless device may communicate with a network device bi-directionally. For example, in a WLAN, a wireless device may communicate with an associated AP via downlink and UL. The downlink (or forward link) may refer to the communication link from the AP to the station, and the uplink (or reverse link) may refer to the communication link from the wireless device to the AP.

Some wireless devices may have two or more co-located radios for communicating using different radio access technologies (RATs). Co-location of different RATs in a wireless device, such as a smartphone, may interfere with each other when they operate on the same or adjacent channels. Accounting for interference at one radio due to a co-located radio may allow for more efficient processing of desired signals.

### SUMMARY

The described techniques relate to improved methods, systems, devices, or apparatuses that support interference mitigation with subspace projection. Generally, the described techniques provide for subspace projection based interference mitigation. A wireless device may transmit and receive signals using radio frequency (RF) chains associated with multiple radios configured for different radio access technologies (RATs). The wireless device may determine a signal of interest for each physical antenna of a set of RF chains associated with a RAT used to receive a desired signal. RF chains of the wireless device may be mapped to a virtual antenna configuration used to mitigate interference (e.g., from signals transmitted over different RATs) and subsequently process the desired receive signal. A determined interference channel may be used along with the determined signal of interest to map the RF chains to the virtual antenna configuration. In some cases, a mapping matrix used to map RF chains to virtual antennas associated with weaker interference may be realized based on an eigenvalue decomposition of a determined spatial covariance matrix.

A method of wireless communication is described. The method may include transmitting a first signal using a first set of RF chains that is associated with a radio configured for a first RAT, receiving a second signal using a second set of RF chains that is associated with a radio configured for a second RAT, mapping a physical antenna of each RF chain of the first set of RF chains and a physical antenna of each RF chain of the second set of RF chains to a virtual antenna configuration, and processing the second signal using the virtual antenna configuration.

An apparatus for wireless communication is described. The apparatus may include means for transmitting a first signal using a first set of RF chains that is associated with a radio configured for a first RAT, means for receiving a second signal using a second set of RF chains that is associated with a radio configured for a second RAT, means for mapping a physical antenna of each RF chain of the first set of RF chains and a physical antenna of each RF chain of the second set of RF chains to a virtual antenna configuration, and means for processing the second signal using the virtual antenna configuration.

Another apparatus for wireless communication is described. The apparatus may include a processor, memory in electronic communication with the processor, and instructions stored in the memory. The instructions may be operable, when executed by the processor, to cause the apparatus to transmit a first signal using a first set of RF chains that is associated with a radio configured for a first RAT, receive a second signal using a second set of RF chains that is associated with a radio configured for a second RAT, map a physical antenna of each RF chain of the first set of RF chains and a physical antenna of each RF chain of the second set of RF chains to a virtual antenna configuration, and process the second signal using the virtual antenna configuration.

A non-transitory computer readable medium for wireless communication is described. The non-transitory computer-readable medium may include instructions executable by a processor to transmit a first signal using a first set of RF chains that is associated with a radio configured for a first RAT, receive a second signal using a second set of RF chains that is associated with a radio configured for a second RAT, map a physical antenna of each RF chain of the first set of RF chains and a physical antenna of each RF chain of the second set of RF chains to a virtual antenna configuration, and process the second signal using the virtual antenna configuration.

Some examples of the method, apparatus, and non-transitory computer-readable medium described above may further include processes, features, means, or instructions for determining a SoI associated with the second RAT for each physical antenna of the second set of RF chains. Some examples of the method, apparatus, and non-transitory computer-readable medium described above may further include processes, features, means, or instructions for determining an interference channel associated with the physical antenna of each RF chain of the first set of RF chains and the physical antenna of each RF chain of the second set of RF chains, wherein the mapping may be based at least in part on the determined SoI and the determined interference channel.

Some examples of the method, apparatus, and non-transitory computer-readable medium described above may further include processes, features, means, or instructions for identifying one or more virtual antennas with a weaker interference value than at least one other virtual antenna based at least in part on the determined interference channel, wherein the virtual antenna configuration comprises the identified one or more virtual antennas.

In some examples of the method, apparatus, and non-transitory computer-readable medium described above, mapping the physical antenna of each RF chain of the first set of RF chains and the physical antenna of each RF chain of the second set of RF chains to the virtual antenna configuration comprises: determining a spatial covariance matrix. Some examples of the method, apparatus, and non-transitory computer-readable medium described above may further include processes, features, means, or instructions for determining a mapping matrix that may be based at least in part on an eigenvalue decomposition (EVD) of the spatial covariance matrix.

Some examples of the method, apparatus, and non-transitory computer-readable medium described above may further include processes, features, means, or instructions for computing values of the mapping matrix based at least in part on a set of smallest eigenvalues of the EVD, wherein identifying the one or more virtual antennas with the weaker interference value may be based at least in part on the computing.

Some examples of the method, apparatus, and non-transitory computer-readable medium described above may further include processes, features, means, or instructions for computing values of the mapping matrix based at least in part on the interference channel using a Gram-Schmidt orthonormalization procedure.

In some examples of the method, apparatus, and non-transitory computer-readable medium described above, the spatial covariance matrix may be determined during periods of idle mode reception.

Some examples of the method, apparatus, and non-transitory computer-readable medium described above may further include processes, features, means, or instructions for determining a channel matrix for data demodulation during a channel sounding interval, wherein the channel matrix for data demodulation may be based at least in part on the mapping matrix.

In some examples of the method, apparatus, and non-transitory computer-readable medium described above, the interference channel may be based at least in part on interference due to the transmitting according to the first RAT.

In some examples of the method, apparatus, and non-transitory computer-readable medium described above, the interference channel may be based at least in part on interference that comprises at least one of duplexer and tuner impedance mismatch, board coupling from a power amplifier, or limited isolation between the physical antennas.

In some examples of the method, apparatus, and non-transitory computer-readable medium described above, the physical antenna of each RF chain corresponds to a number of receive antennas of a device.

### BRIEF DESCRIPTION OF THE DRAWINGS

FIG. 1 illustrates an example of a system for wireless communication that supports interference mitigation with subspace projection in accordance with aspects of the present disclosure.

FIG. 2 illustrates an example of a wireless local area network (WLAN) that supports interference mitigation with subspace projection in accordance with aspects of the present disclosure.

FIG. 3 illustrates an example of a wireless device that supports interference mitigation with subspace projection in accordance with aspects of the present disclosure.

FIG. 4 illustrates an example of a processing flow that supports interference mitigation with subspace projection in accordance with aspects of the present disclosure.

FIG. 5 illustrates an example of a processing timeline that supports interference mitigation with subspace projection in accordance with aspects of the present disclosure.

FIG. 6 illustrates an example of a processing timeline that supports interference mitigation with subspace projection in accordance with aspects of the present disclosure.

FIG. 7 illustrates an example of a process flow that supports interference mitigation with subspace projection in accordance with aspects of the present disclosure.

FIGS. 8 through 10 show block diagrams of a device or devices that support interference mitigation with subspace projection in accordance with aspects of the present disclosure.

FIG. 11 illustrates a block diagram of a system including a wireless device that supports interference mitigation with subspace projection in accordance with aspects of the present disclosure.

FIGS. 12 through 14 illustrate methods for interference mitigation with subspace projection in accordance with aspects of the present disclosure.

### DETAILED DESCRIPTION

Spatial processing may be employed within a wireless device that has two or more co-located radios for communicating using different radio access technologies (RATs). Such techniques may increase the efficiency with which such devices process desired signals.

By way of example, a transmission on one radio may interfere with a reception on another radio. Due to their proximity, a regular transmission on one radio employing one RAT may cause corrupted reception at another radio employing another the other RAT. For example, a co-located Long Term Evolution (LTE) radio and a wireless local area network (WLAN) radio may interfere with each other when they operate on adjacent channels in the 2.4 GHz band (e.g., channel 1 of WLAN and band 40 of time-division LTE (TD-LTE)). stations (STAs) or user equipment (UEs) utilizing current co-located RAT interference countermeasures may experience significant communication degradation (e.g., harmonic distortion). Desense (e.g., degradation in receiver sensitivity due to same device noise sources) may be hard to predict as it may depend on the choice of device components and the physical original equipment manufacturer (OEM) board layout. Improved methods to reduce self interference generated by concurrent usage of multiple RATs on the same device may thus increase system performance in such scenarios.

Current filters and counter measures may be costly and increase bill of materials (BOM) of producing such devices. Further, current interference mitigation techniques may be ineffective in scenarios where the interference to noise ratio (INR) is high or for interference such as harmonic distortion due to the inability to induce such interference. Additional counter measures may be necessary to avoid such scenarios which may be associated with system degradation. So a new digital null-space-based linear interference mitigation (NLIM) process, as described herein, may use spatial processing for subspace based interference mitigation.

The NLIM process may include techniques related to null space linear interference mitigation. A desired signal, which may be referred to as a signal of interest (SoI), may correspond to a subset of a total number of physical chains a device is capable of utilizing (e.g., chains dedicated to reception over a particular RAT). To mitigate interference on the SoI, the SoI subset of chains and additional receive (Rx) chains may be mapped to virtual antennas for processing of spatial streams corresponding to the SoI. Time domain samples of a signal received over all physical chains may be utilized to estimate a vector subspace associated with interference on the signal (e.g., using vectors representing interference across each of the physical chains).

As described herein, the NLIM process may then determine a mapping matrix that lies in a vector subspace that is orthogonal to the subspace estimated to be associated with interference across the physical chains (e.g., by constructing the mapping matrix with columns that are orthogonal to estimated interference vectors). The mapping matrix may then be applied to the signal to produce a mapped signal or virtual antennas (e.g., spatial streams) with orthogonal interference components canceling out, and the wireless device may process the mapped signal, thus mitigating interference of the original SoI.

Aspects of the disclosure introduced above are described more fully below in the context of a wireless communications system. Examples of wireless systems supporting subspace based interference mitigation in addition to example front end interference and processing timelines are then described. Aspects of the disclosure are further illustrated by and described with reference to apparatus diagrams, system diagrams, and flowcharts that relate to interference mitigation with subspace projection

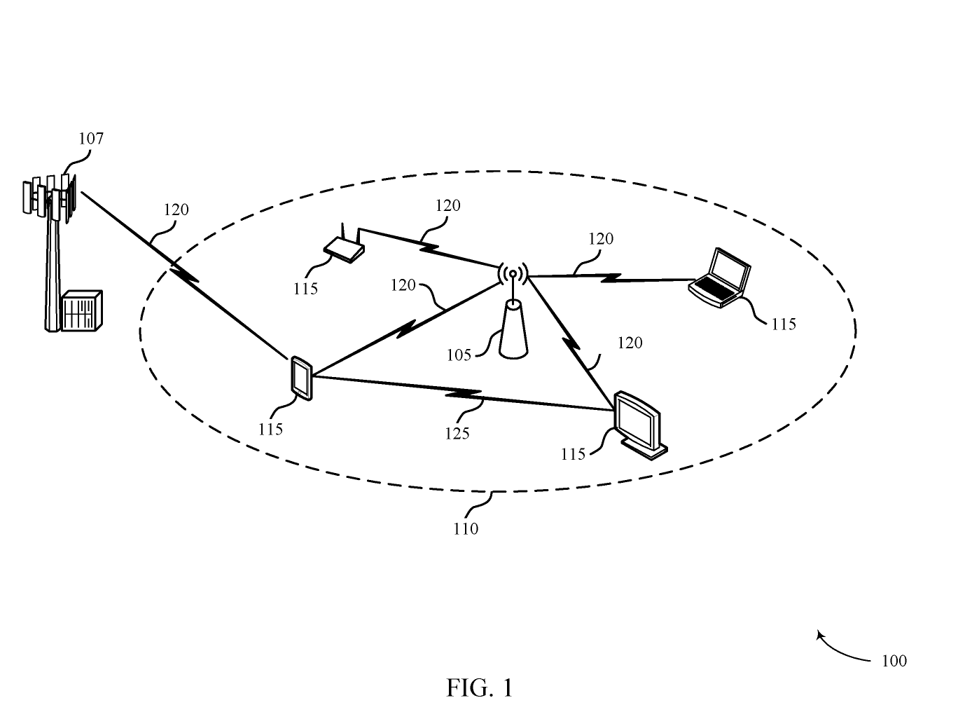

FIG. 1 illustrates a WLAN 100 (also known as a Wi-Fi network) configured in accordance with various aspects of the present disclosure. The WLAN 100 may include an AP 105 and multiple associated wireless devices 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated wireless devices 115 may represent a basic service set (BSS) or an extended service set (ESS). The various wireless devices 115 in the network are able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS.

In some cases, a wireless device 115 may be used interchangeably with a wireless station or user equipment. Wireless device 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless device 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of things (IoT) device, an Internet of Everything (IoE) device, a machine type communication (MTC) device, an appliance, an automobile, or the like.

Although not shown in FIG. 1, a wireless device 115 may be located in the intersection of more than one coverage area 110 and may associate with more than one AP 105. A single AP 105 and an associated set of wireless devices 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two wireless devices 115 may also communicate directly via a direct wireless link 125 regardless of whether both wireless devices 115 are in the same coverage area 110. Examples of direct wireless links 120 may include Wi-Fi Direct connections, Wi-Fi Tunneled Direct Link Setup (TDLS) links, and other group connections. wireless devices 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

A wireless device 115 of WLAN 100 may include co-located radios which may additionally support communications with other networks operating using different RATs. For example, a wireless device 115 may communicate with a base station 107 (e.g., an LTE base station) in addition to AP 105. Wireless device 115 communications with AP 105 and base station 107 may utilize different RATs and may occur simultaneously or in a time division duplexing (TDD)-like scheme. In some cases, a base station 107 and a wireless device 115 may communicate using more than one carrier. Each aggregated carrier is referred to as a component carrier (CC). Each component can have a bandwidth of, e.g., 1.4, 3, 5, 10, 15 or 20 MHz. In some cases, the number of CCs can be limited to, e.g., a maximum of five 20 MHz carriers, giving maximum aggregated bandwidth is 100 MHz. In frequency division duplexing (FDD), the number of aggregated carriers can be different in downlink and uplink. The number of uplink component carriers may be equal to or lower than the number of downlink component carriers. The individual component carriers can also be of different bandwidths. For TDD, the number of CCs as well as the bandwidths of each CC will normally be the same for downlink and uplink. Component carriers may be arranged in a number of ways. For example, a carrier aggregation (CA) configuration may be based on contiguous component carriers within the same operating frequency band, i.e., called intra-band contiguous CA. Non-contiguous allocations can also be used, where the component carriers may be either be intra-band, or inter-band.

A wireless device 115 may have hardware supporting more than one RAT to facilitate the communications with both the AP 105 and base station 107. For example, radios, antennas, transceivers, or the like, supporting different RATs may be co-located on a wireless device 115. In scenarios where wireless device 115 communicates using two different RATs at roughly the same time, communications on one RAT may cause interference with the communications on the other RAT (e.g., a transmitter associated with one RAT interferes with the reception of communications of a second RAT). For example, the wireless device 115 may communicate with a base station 107 over an LTE network while communicating with the AP 105 over WLAN.

There may be multiple sources of interference in systems supporting concurrent use of multiple RATs (e.g., WLAN 100). The transmitted signal associated with a RAT may leak into the reception bandwidth of another RAT through several mechanisms due to the non-linearity of the radio frequency (RF) front end of wireless device 115. For example, spurious interfering signals may be generated in a zero intermediate frequency (ZIF) architecture due to non-linear RF/Analog component behavior at the transmitter.

Devices 115 that support multiple RATs may also be prone to issues from harmonic distortion. Harmonic distortion may refer to the non-linearity of the front end due to harmonic components of transmitted waveforms falling within the band a receiving radio is operating within (e.g., a reception band). Harmonics of a local oscillator (LO) used for up conversion may create transmission signal components within the reception band of the different RAT. For example, the receiver may demodulate RF signals centered around integer multiples of a carrier frequency used for transmission by another RAT. Inter-modulation distortion (IMD) may occur where modulation of a transmitted waveform generates interference within the band of the receiving technology.

Non-linear operations of two or more transmitters may result in IMD, which can cause sensitivity loss in a receiver located on the same device. For example, simultaneous operation of a WLAN transmitter in a 2.4 GHz band and a WWAN transmitter in the 800 MHz band may result in a second order IMD component (IMD2) that falls into the receive band of a GPS receiver (e.g., 2.4 GHz−800 MHz*1.6 GHz), thereby resulting in sensitivity loss in the GPS receiver. Interference may also arise due to adjacent channel leakage (ACLR) from neighboring or adjacent bands. For example in 2.4 GHz Wi-Fi operation there may be interference due to nearby adjacent LTE band transmissions (e.g., B40, B41, B7, B38).

Countermeasures to reduce interference may include RF filters, analog interference cancellation, coexistence management, and algorithms for interference cancellation. However, additional RF filters may be costly and increase bill of materials (BOM) of producing such devices by original equipment manufacturers. Further, additional costly filters may increase overall insertion loss (e.g., by 2-3 dB) for the aggressor RAT (e.g., transmitting RAT interfering with a victim RAT associated with a co-located receiver), thus increasing power amplifier power consumption. Analog interference cancellation (e.g., subtracting an interference signal from a received signal in the analog domain prior to the analog to digital converter) may also increase BOM and the noise figure (NF) (e.g., from staying in the analog RF domain), and may further result in routing problems on the printed circuit board (PCB).

In the digital domain, a coexistence (COEX) manager may reduce aggressor power, and prevent transmission on a RAT during reception of the victim RAT (e.g., time division multiplexing (TDM) operation over the different RATs). This may be referred to as RAT prioritization, and may reduce system throughput. Various techniques (e.g., digital domain interference techniques) may be applied in scenarios where the aggressor signal is within the dynamic range of the receiver. Such processes or algorithms may exploit the fact that the interference comes from another radio on the same chip, thus transmission knowledge (e.g., digital domain transmission samples) may be used to help cancel interference experienced at the receiver of another RAT.

Non-linear operations of two or more transmitters may further result in IMD, which may cause sensitivity loss in a receiver located on the same device. For example, simultaneous operation of a WLAN transmitter in the 2.4 GHz band and a WWAN transmitter in the 800 MHz band can result in a second order IMD component (IMD2) that falls into the receive band of a GPS receiver (e.g., 2.4 GHz−800 MHz*1.6 GHz), thereby resulting in sensitivity loss in the GPS receiver. Similarly, simultaneous operation of a WLAN transmitter in a 5.660 GHz channel and a WWAN transmitter in a 1860 MHz channel can result in a third order IMD component (IMD3) that falls into a 1940 MHz receive channel of a WWAN receiver (e.g., 5660 MHz−2×1860 MHz=1940 MHz), thereby resulting in sensitivity loss in the WWAN receiver. A filter for removing IMD components may be provided at the input of the affected receiver (e.g., the victim receiver). Adequate filters may be costly and increase BOM of producing such devices. For example, Table 1 shows example coupling mechanisms (e.g., interference) and scenarios.

TABLE 1

| | | Aggressor | Victim | Reported |
|---|---|---|---|---|
| Mechanism | Sub-type | Bands | Bands | De-sense |
| Harmonic | RF/Analog | B1, B2, B3, | WLAN 5 | Up to |
| | non- | B4, B9, B10, | GHz | ~40 dB |
| | linearity | B24, B25 | | |
| | LO | WLAN | B2, B3, | ~10 dB |
| | Harmonics | 5 GHz | B9, B25 | |
| ACLR | — | B40, B7, | WLAN | Up to |
| | | B41 | 2.4 GHz | ~45 dB |
| | | WLAN | B40, B7, | Up to |
| | | 2.4 GHz | B41 | ~20 dB |
| IMD | — | WLAN 2.4 | B7, B25, B4, | Up to |
| | | and 5 G | B3, B2, B18, | ~20 dB |
| | | | B20 | |

Various techniques may further be used to mitigate same device interference using, for example, knowledge of transmission information. For example, non-linear interference cancellation (NLIC) is a digital baseband algorithm that may cancel interference caused by transmitted signals and spurs of diverse nature (e.g., harmonic distortion, IMD, etc.). However, adoption of certain technologies (e.g., WLANs) in co-located RAT devices may introduce additional complexities not adequately addressed by NLIC-like methods, specifically in ACLR scenarios.

For example, in a WLAN reception case (e.g., Wi-Fi is victim), additional architectural complexities may arise from the need to route samples from one modem to another. Further, additional algorithmic complexity may result from unfeasibility to fit into WLAN receiver timelines. Coexistence techniques utilizing transmission power backoff and inter-RAT time division multiplexing may thus be used to avoid such issues (e.g., via use of a coexistence manager) but may be associated with decreased system throughput.

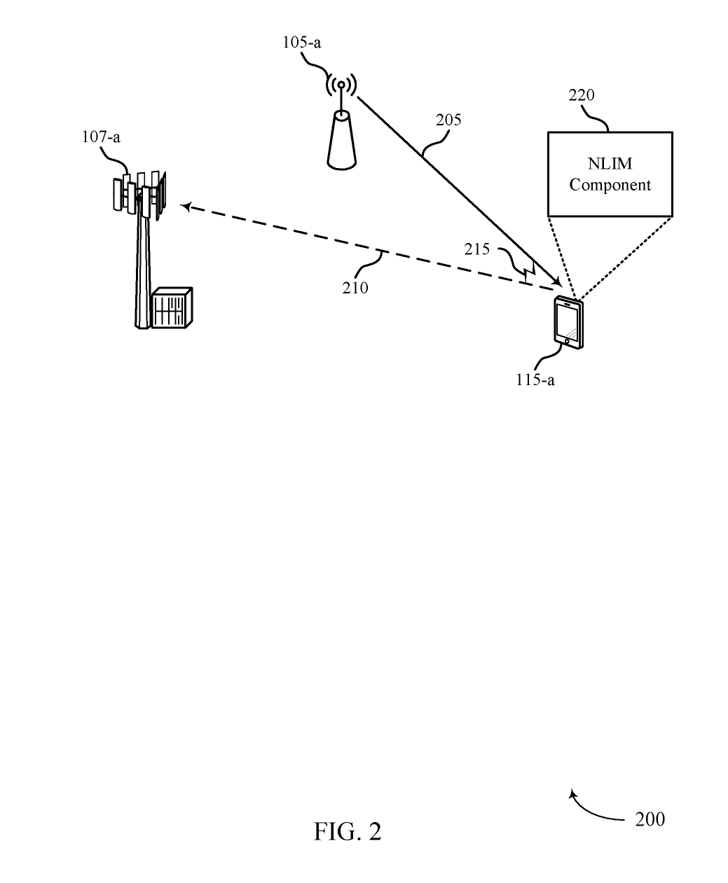

FIG. 2 illustrates an example of a wireless communications system 200 for interference mitigation with subspace projection. Wireless communications system 200 may include wireless device 115-a implementing new digital NLIM techniques (e.g., algorithms) utilizing spatial processing for subspace based interference mitigation. In the present example, wireless device 115-a may transmit communications over uplink 210 to base station 107-a in addition to receiving communications over downlink 205 from AP 105-a. Thus, communications over uplink 210 and downlink 205 may occur via co-located receivers operating with different RATs (e.g., LTE and Wi-Fi). Interference 215 associated with co-located and multiple RAT receiver operation may be mitigated with use of NLIM component 220 of wireless device 115-a. NLIM component 220 may perform aspects of functions relating to NLIM techniques described herein.

A SoI may correspond to spatial streams associated with a subset of a total number of physical chains a device is capable of utilizing (e.g., chains dedicated to reception over downlink 205 associated with AP 105-a). Time domain samples of a signal received over all physical chains may be utilized to estimate a vector subspace associated with interference on the signal (e.g., using vectors representing interference across each of the physical chains). NLIM techniques may then determine a mapping matrix that lies in a vector subspace that is orthogonal to the subspace estimated to be associated with interference across the physical chains (e.g., by constructing the mapping matrix with columns that are orthogonal to estimated interference vectors). The mapping matrix may then be applied to the signal to produce a mapped signal with orthogonal interference components canceling out, thus mitigating interference of the original SoI. In some examples, a coexistence manager may manage NLIM and may identify available Rx chains, desired spatial streams for reception, and other factors to implement NLIM techniques.

NLIM mapping may improve system performance with respect to, for example, packet detection, gain control, bit error rate (BER), or the like. Specifically, the NLIM mapping in the RxTD control path may server the purpose of improving packet detection and gain control (e.g., signal sizing) in the presence of the aggressor signal (e.g., on-device transmitting signal). The RxTD control path may also account for initial time/frequency recover, which may influence the decoding performance of control fields in the non-beamformed part of the frame. NLIM methods may significantly improve such processes. Additionally, NLIM mapping in the data path may improve BER performance. The NLIM mapping may be performed in RxFD depending on the demodulation load (e.g., arising from shared hardware across the multiple RATs) for the specific concurrency scenario. In the frequency domain, different NLIM mappings may be used for each subcarrier or group of subcarriers, thus addressing multipath components of the same aggressor signal. Frequency domain approaches may be applied in scenarios where additional RF chains on device 115-a are unavailable. In such scenarios RxFD may sustain the load, and minimum mean square error (MMSE) beamforming (e.g., interference nulling) may be implemented.

Two or more physical chains may be mapped to at least one virtual antenna for frequency domain processing of an associated spatial stream to be received. For example, a four-physical chain signal may be mapped (e.g., via a spatial mapping matrix) to two virtual antennas, an effective channel may then be extracted from the mapped signal for data demodulation in the frequency domain.

The spatial mapping matrix may be obtained by solving for the eigenvalue decomposition (EVD) of a spatial covariance matrix (e.g., using the second order statistics of the interference to calculate an effective interference vector). The spatial covariance matrix may be obtained during, for example, inter-packet gaps (e.g., short interframe space (SIFS) where the solution of interest (SoI) is not present. That is, estimates of the spatial covariance matrix may be computed when the receiving chain is idle (e.g., when wireless device 115-a is not receiving packets over downlink 205 from AP 105-a) and updated in the order of, for example, 10s or 100s of ms. The interference plus noise covariance matrix may be computed for each subcarrier or group of subcarriers. In some cases, this procedure may be associated with spectral scanning. During the inter-packet gap, the covariance of interference and noise may be estimated directly from the received time domain samples. Effective interference vectors may thus be obtained from the spatial covariance matrix and used to determine the column vectors of the spatial mapping matrix.

As discussed above, the spatial mapping matrix may then obtained as a sub-matrix of the EVD of the spatial covariance matrix. The column vectors of the spatial whitening matrix may be the eigenvectors corresponding to the smallest eigenvalues (e.g., to represent the subspace where interference is weaker). In some cases, the EVD may be computed by reusing the singular value decomposition (SVD) of the shared firmware (FW) or processor of the device 115-a. Therefore, the columns of the spatial mapping matrix may be orthonormal vectors which are also orthogonal to the interference vector(s). Consequently, if an interference vector (e.g., associated with interference 215) is known prior to analysis of the spatial covariance matrix, the columns of the spatial mapping matrix may be computed via a Gram-Schmidt orthonormalization procedure.

Interference vectors may also be estimated using non-linear interference cancellation or other digital domain techniques. Alternatively, different signal to interference noise ratio (SINR) maximization criteria may be chosen to calculate a spatial mapping matrix based on a different eigenvalue problem (e.g., a MMSE-like solution). These alternative methods may apply to scenarios where the SoI channel matrix is known.

The effective channel matrix used for data demodulation may be estimated during channel sounding procedures (e.g., occurring every 100 ms) resulting in interference alignment where a transmitter may concentrate the energy of the SoI in the subspace orthogonal to the interferer.

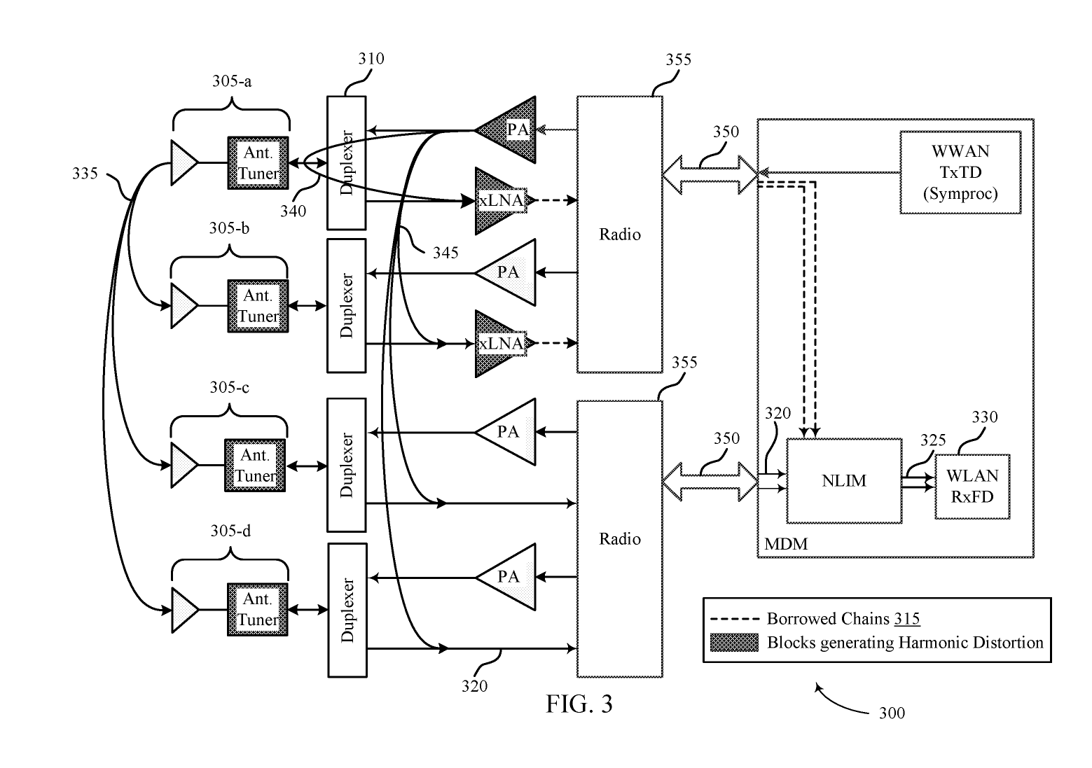

FIG. 3 illustrates an example of a wireless device 300 that supports interference mitigation with subspace projection. The present example shows wireless device 300 transmitting LTE communications while simultaneously receiving Wi-Fi communications. Antenna 305-a may be shared between LTE transmissions and Wi-Fi receptions, while antenna 305-b, antenna 305-c, and antenna 305-d may be devoted to Wi-Fi reception. In this case, signal transmissions from antenna 305-a may leak into the other receive chains used for Wi-Fi reception. Physical chains associated with reception of the signal intended to be received (e.g., chains associated with two spatial streams 320) combined with borrowed chains 315 may undergo NLIM techniques to produce two virtual antennas 325 for processing at the WLAN 330. Further, wireless device 300 may include one or more radio-baseband buses 350 in addition to one or more radio chips 355. Such radio chips may interface RF front end components (e.g., antennas 305) with processing components (e.g., for NLIM processing) via radio-baseband buses. The present example and discussion depicts a single example. Wireless devices 115 implementing alternate RATs such as Bluetooth, GPS, or the like, in addition to wireless devices 115 with different front end configurations of antennas and RF chains, may utilize described techniques by analogy.

In the example of FIG. 3, a signal model for 4 Rx antennas, 2 spatial stream WLAN configuration (e.g., spatial streams 320), and a single-antenna interferer (e.g., antenna 305-a) where k is the sample index, may be modeled as,

y[k]=Hs[k]+h_{I}x[k]+n[k] (1)

where y[k] is a 4×1 Rx signal matrix corresponding to the signal received at all 4 antennas 305. H is a 4×2 SoI channel matrix that may comprise precoding or precoding processing from the transmission scheme (e.g., AP 105 transmission precoding), s[k] is a 2×1 SoI matrix (e.g., corresponding to the two spatial streams 320), h_{I} is a 4×1 interference channel matrix, x[k] is a 1x1 interference scalar, and n[k] is a 4×1 noise matrix (e.g., from thermal noise), all on a per k sample basis.

Applying NLIM operation or mapping on Equation 1 includes introducing a 2×4 mapping matrix to map the 4 physical antennas to 2 virtual antennas 325. Thus, the mapped signal may be modeled as,

\tilde{y}[k]=W^{H}y[k]=W^{H}Hs[k]+W^{H}h_{I}x[k]+W^{H}n[k] (2)

where \tilde{y}[k] is a 2×1 mapped signal matrix that represents the two virtual antennas 325, W^{H} is the 2×4 mapping matrix, W^{H}H is a 2×2 effective channel matrix (e.g., used for data demodulation) and W^{H}h_{I}x[k] is the effective interference. That is, a mapping matrix W^{H} may be applied to a signal received over 3 or more physical chains (e.g., Equation 1) to obtain a virtual signal or spatial streams associated with virtual antennas (e.g., Equation 2). In addition to processing the mapped signal, the effective channel may be used for data demodulation in the frequency domain. The interference channel matrix, h_{I}, may not be known in general. As discussed above, potential contributing factors to such interference may include limited antenna isolation interference 335, duplexer/tuner impedance mismatch interference 340 (e.g., from power amplifier and low noise amplifier interactions with duplexers 310), and/or board coupling interference 345.

Second order statistics of the interference (e.g., a spatial covariance matrix) may be used to determine h_{I}. For example, in the context of Wi-Fi, it may be possible to exploit inter-packet gaps (e.g., SIFS) or idle periods when a device is not actively receiving a packet (e.g., the SoI is not present, aside from blockers). It may be possible to associate this procedure with spectral scanning. During SIFS, the covariance of interference and noise may be estimated directly form the received time domain samples. For example, the covariance of interference and noise may be represented as,

$${C}_{II} = \frac{1}{N} {\sum }_{k = 0}^{N - 1} y [ k ] {y}^{H} [ k ] \approx {h}_{I} {h}_{I}^{H} + {σ}^{2} I \qquad ( 3 )$$

y^{H} [k] and h_{I}^{H} may respectively refer to the Hermitian conjugate or the Hermitian transpose of the signal matrix y[k] and the interference channel matrix h_{I}. The covariance of interference and noise matrix C_{II}, may be computed within the SIFS. And the processes may be updated for each new computation of C_{II}.

The estimated covariance matrix, C_{II}, may be used to determine the mapping matrix W^{H}. The spatial mapping matrix W may be partitioned in to column vectors corresponding to the number of spatial streams (e.g., for two spatial streams W=[w₁ w₂]). W may be selected to minimize INR post-mitigation. That is,

$${min}_{W} \frac{tr ( {W}^{H} {C}_{II} W )}{{σ}_{n}^{2} \cdot tr ( {W}^{H} W )} = \frac{{w}_{1}^{H} {C}_{II} {w}_{1} + {w}_{2}^{H} {C}_{II} {w}_{2}}{{σ}_{n}^{2} \cdot ( {w}_{1}^{H} {w}_{1} + {w}_{2}^{H} {w}_{2} )} \qquad ( 4 )$$

Where, tr( ) refers to the trace of the enclosed matrix and W is selected to minimize the ratio of Equation 4. Minimizing Equation 4 may be solved as an eigenvalue problem. W may be obtained as a 4×2 sub-matrix of the EVD of C_{II}. For example, the columns w₁ and w₂ may be the two eigenvectors corresponding to the smallest eigenvalues of the EVD (e.g., eigenvectors supporting or spanning the subspace where interference is weaker). In some cases, the EVD may be computed by reusing the SVD shared FW. Therefore, the columns w₁ and w₂ may be orthogonal to the interference and effectively null out the interference.

In low-rank interference scenarios (e.g., a single interferer, or rank one, with four receiving antennas) the matrix C_{II} may imply which subspace is orthogonal to the interference. For example, w₁ and w₂ may be determined such that they are orthogonal to the interference and when the matrix W is applied to the received signal y[k] the interference is nulled out. That is, for a single interferer model, the columns of W are orthonormal vectors which may also be orthogonal to h_{I}. For example, w₁^{H}h_{I}=0 and w₂^{H}h_{I}=0. If h_{I} is known, w₁ and w₂ may be computed via a Gram-Schmidt orthonormalization procedure. In some cases, h_{I} may be estimated using NLIC. NLIM may be tightly integrated with NLIC.

In some cases, criteria to maximize a SINR may be chosen, thereby yielding a MMSE-like solution. In such cases, the Eigenvalue problem may differ and some knowledge of the SoI channel, H, may be used. Such cases may be applied to frequency domain solutions as H is estimated in the frequency domain.

The number of Rx antennas may limit the number of spatial streams that can be received in addition to the robustness of the techniques against multiple coupling paths. For example, Table 2 shows example combinations of aggressor antennas and available Rx antennas to illustrate the potential spatial stream processing capabilities of NLIM in different scenarios.

TABLE 2

| | | | |
|---|---|---|---|
| 1 WLAN Rx | 2 WLAN Rx | 2 + 1 WLAN Rx | 2 + 2 WLAN Rx |

| | | | |
|---|---|---|---|
| 1 Aggressor | 1 SS | 2 SS | 3 SS |
| (e.g., 1 Tx WWAN UL) | | | |
| 2 Aggressors | | 1 SS | 2 SS |
| (e.g., 2 Tx MU-MIMO | | | |
| WWAN UL) | | | |

However, NLIM may still be applicable in scenarios where additional Rx antennas are not available. Blank elements in Table 2 may refer to these situations where spatial processing may not be possible. In such scenarios, the data path NLIM mapping may be performed in the frequency domain and may be frequency-dependent. The interference covariance matrix may thus be computed for each subcarrier or group of subcarriers as shown in Equation 5.

$${C}_{II} ( f ) = \frac{1}{N} {\sum }_{n = 0}^{N - 1} Y [ f , n ] {Y}^{H} [ f , n ] \approx {H}_{I} ( f ) {H}_{I}^{H} ( f ) + {σ}^{2} I \qquad ( 5 )$$

NLIM may provide an approximation of the spatial whitening matrix for large INR. Considering the interference covariance matrix,

C_{II}=I+INR·H_{I}h_{I}^{H} (6)

the inverse may be written as,

$${C}_{II}^{- 1} = I - \frac{I N R}{1 + I N R} {h}_{I} {h}_{I}^{H} = [ \begin{matrix}{u}_{h} & {U}_{h}\end{matrix} ] [ \begin{matrix}1 - \frac{I N R}{1 + I N R} & 0 \\ 0 & diag ( 1 )\end{matrix} ] [ \begin{matrix}{u}_{h}^{H} \\ {U}_{h}^{H}\end{matrix} ] \qquad ( 7 )$$

From equation 7 it can be realized that for large INR the whitening matrix (e.g., the square root of the inverse of C_{II}) may be approximated as,

$${C}_{II}^{- 1 / 2} \approx [ \begin{matrix}0 \\ {U}_{h}^{H}\end{matrix} ] \qquad ( 8 )$$

which is the NLIM mapping. This property may also hold in scenarios where the interference rank is larger than 1.

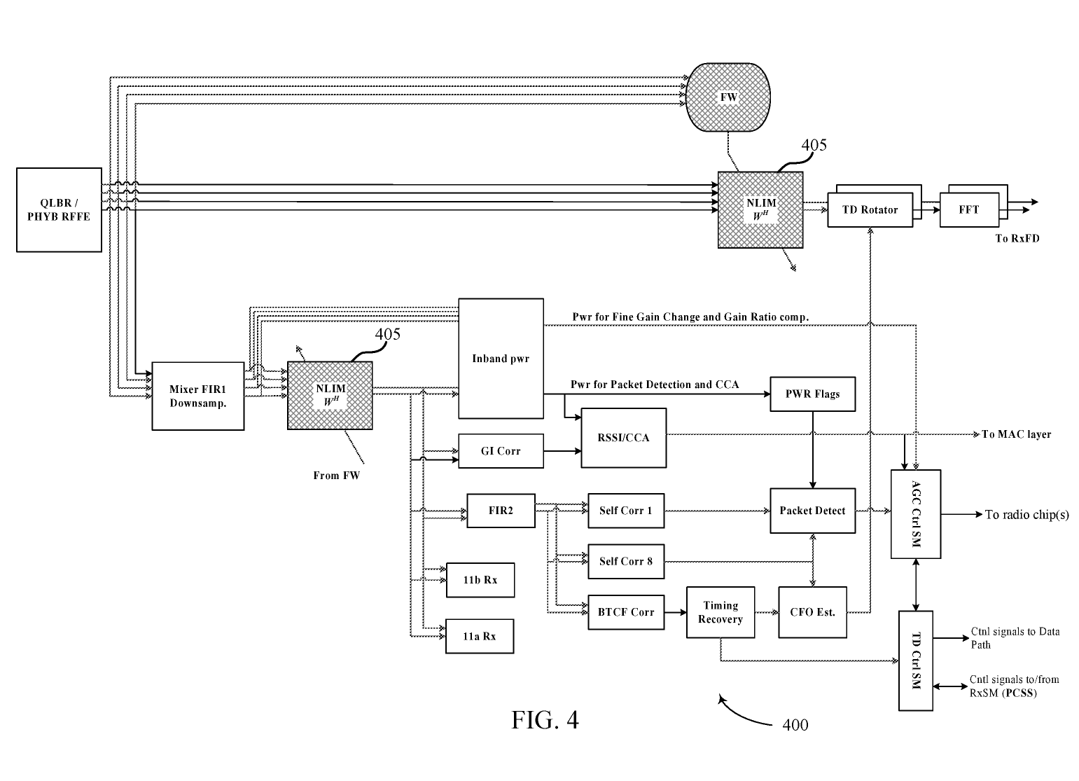

FIG. 4 illustrates an example of a processing flow 400 that supports interference mitigation with subspace projection. Possible locations of NLIM 405 within an example processing chain are depicted to demonstrate that multiple instances of NLIM 405 may be operated at different sampling rates. NLIM inputs may include received signals over the different antennas of a wireless device 115. The signals may be down sampled to a sample rate desired for a fast Fourier transform (FFT) (e.g., a sample rate at which the system is operating). That is, NLIM operations may not require a specific sample rate, and over sampling or down sampling may be dependent on other criteria. While the present example may represent NLIM techniques in time domain processing, implementations in the frequency domain may also be realized.

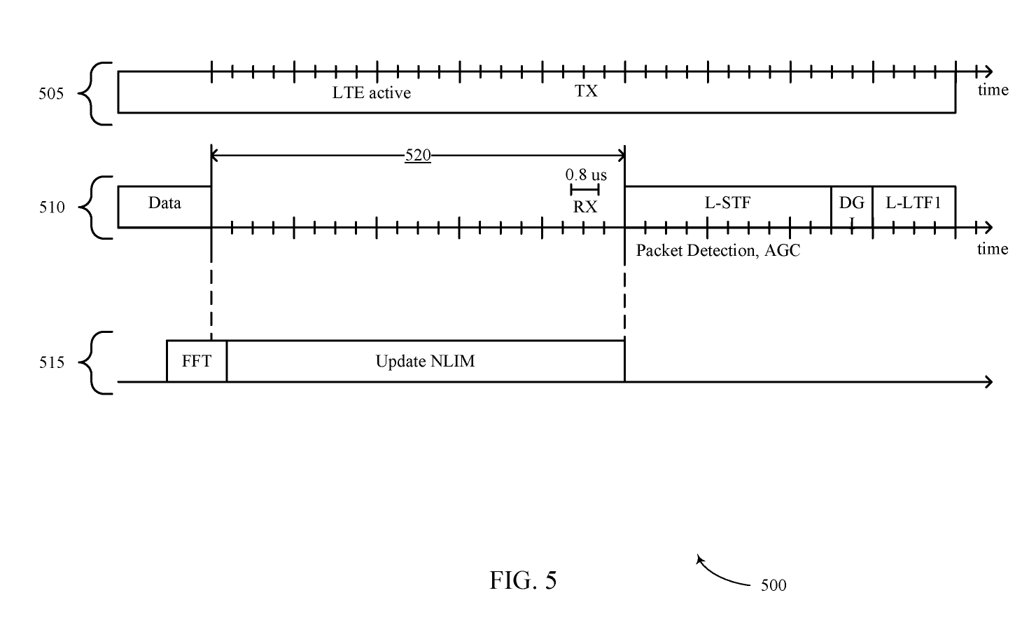

FIG. 5 illustrates an example of a processing timeline 500 that supports interference mitigation with subspace projection. According to the example of FIG. 5, a spatial covariance matrix of the interference plus noise, C_{II}, may be computed to update or train NLIM coefficients. In general, the interference channel, h_{I}, may not be known and C_{II} may be used to obtain the spatial mapping matrix, W. Transmission timeline 505, reception timeline 510, and NLIM processing timeline 515 may illustrate NLIM coefficient updating during, for example, SoI reception idle periods.

The example of FIG. 5 may, for example, apply to Wi-Fi implementations where gaps 520 (e.g., interframe space) exist between transmitted and received packets. Gap 520 may not be fixed and may depend on several parameters. In some cases, the gap 520 may include a SIFS (e.g., 16 us). When an aggressor is transmitting within a gap 520 (e.g., LTE active along transmission timeline 505), samples received during the gap 520 (e.g., samples received along reception timeline 510) may be used to compute the second order statistics of the interference (e.g., see Equation 3). Such computations may be used to train coefficients used in NLIM (e.g., to determine the spatial mapping matrix W, see Equation 4). That is, NLIM may be updated along NLIM processing timeline 515 during gap 520.

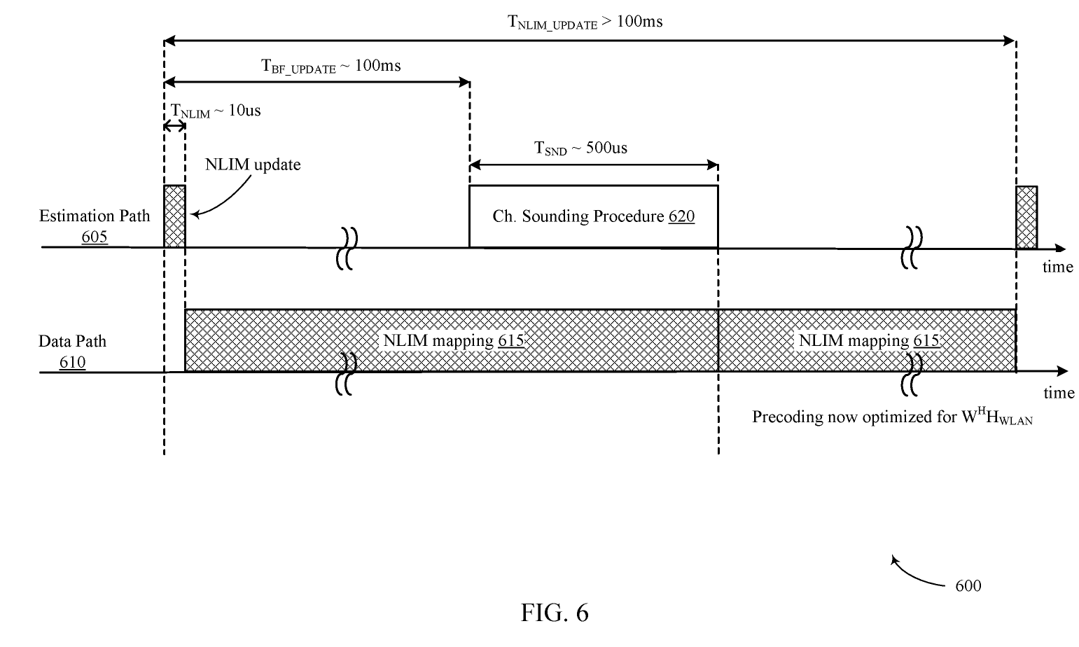

FIG. 6 illustrates an example of a processing timeline 600 that supports interference mitigation with subspace projection. NLIM may be represented in the context of a channel sounding procedure in Wi-Fi. A data path employing NLIM mapping 615 may underlie an estimation path 605 used for a channel sounding procedure 620 to increase effectiveness of AP 105 precoding.

When Wi-Fi employs multiple input multiple output (MIMO) (e.g., a method to exploit multipath propagation and increase a radio links capacity by using multiple transmit and/or receive antennas), an accompanying channel sounding procedure may be used to compute an optimal precoding that a transmitter (e.g., AP 105) should employ. AP 105 may start a channel sounding procedure 620 or an exchange of packets for channel estimation. In some cases, NLIM mapping 615 may underlie operation of the channel sounding procedure 620. In such cases, the precoding an AP 105 choses may be optimized for the effective channel, W^{H}H, which may be the result of the NLIM operation. The AP 105 tuning to the effective channel W^{H}H, instead of the original channel H, which is what the modem receives after NLIM mapping 615 and may thus result in increased overall NLIM performance.

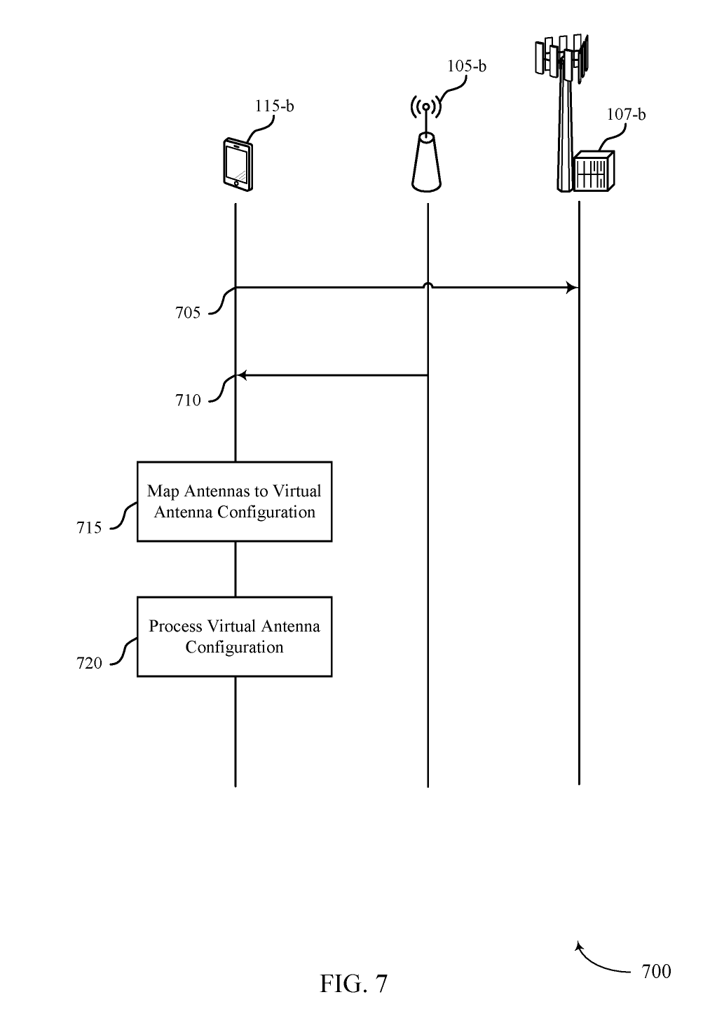

FIG. 7 illustrates an example of a process flow 700 that supports interference mitigation with subspace projection. Process flow 700 may illustrate an example of a procedure for interference mitigation via subspace projection implemented by a wireless device using multiple RATs with co-located radios (e.g., wireless device 115-b).

At step 705, wireless device 115-b may transmit a signal using RF chains associated with a radio configured for a first RAT (e.g., an LTE transmission) to base station 107-b. At step 710, wireless device 115-b may receive a signal using RF chains associated with a radio configured for a second RAT (e.g., a WLAN transmission) from AP 105-b. In some cases, step 705 and step 710 may occur simultaneously. The physical antennas of each RF chain of step 705 and 710 may correspond to a number of receive antennas of wireless device 115-b.

At step 715, wireless device 115-b may map physical antennas of the RF chains associated with both RATs to a virtual antenna configuration. In some cases, a SoI associated with step 710 may be determined for each physical antenna of the RF chains associated with the second RAT. Further, an interference channel associated with all RF chains may be determined. The interference channel may be based on interference from transmissions from step 705 (e.g., from duplexer and tuner impedance mismatch, board coupling from a power amplifier, and/or limited isolation between the physical antennas). The SoI and/or the interference channel may be used to map the physical antennas to the virtual antenna configuration. In some cases, some virtual antennas with a weaker interference value may be based on the interference channel. In such cases, the virtual antenna configuration may include these identified virtual antennas.

A mapping matrix used to perform step 715 may be determined based on an EVD of a spatial covariance matrix. The spatial covariance matrix may be determined during period of idle mode reception. Specifically, the values of the mapping matrix may be computed based on the smallest eigenvalues of the EVD. The previously mentioned virtual antennas associated with weaker interference may be realized based on such computations. Additionally or alternatively, the values of the mapping matrix may be computed based on the interference channel using a Gram-Schmidt orthonormalization procedure. Further, a channel matrix for data demodulation may be determined during a sounding interval based on the mapping matrix. At step 720, wireless device 115-b may process the signal received in step 710 using the virtual antenna configuration realized at step 715.

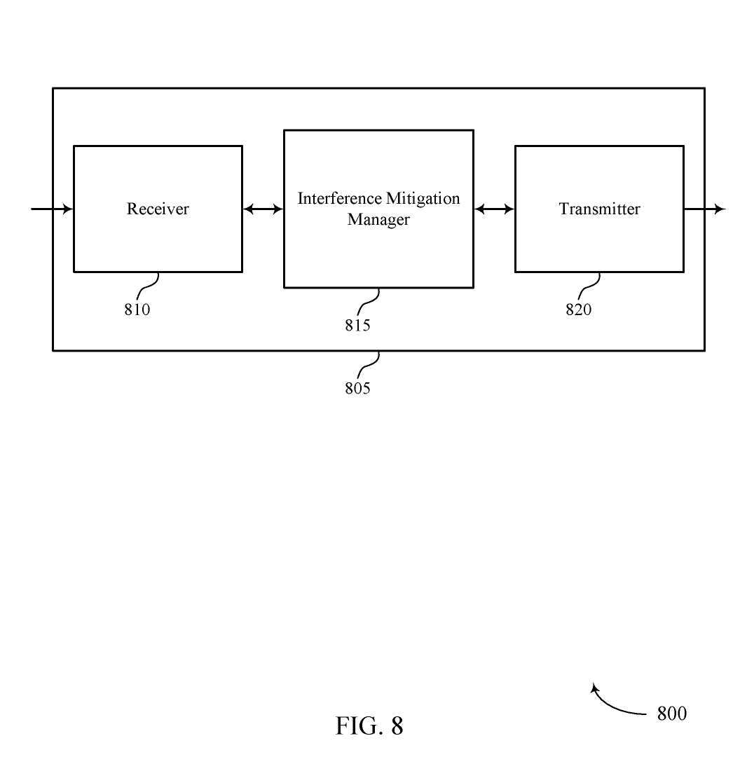

FIG. 8 shows a block diagram 800 of a wireless device 805 that supports interference mitigation with subspace projection in accordance with various aspects of the present disclosure. Wireless device 805 may be an example of aspects of a wireless device 115 as described with reference to FIG. 1. Wireless device 805 may include receiver 810, interference mitigation manager 815, and transmitter 820. Wireless device 805 may also include a processor. Each of these components may be in communication with one another (e.g., via one or more buses).

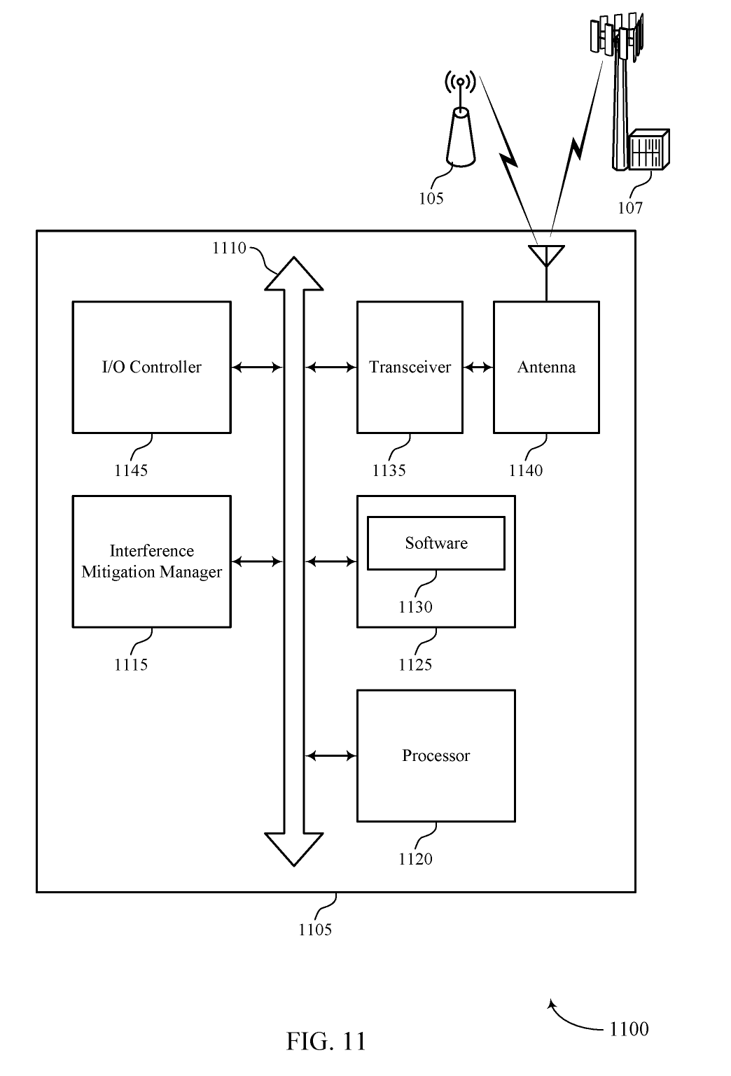

Receiver 810 may receive information such as packets, user data, or control information associated with various information channels (e.g., control channels, data channels, and information related to interference mitigation with subspace projection, etc.). Information may be passed on to other components of the device. The receiver 810 may be an example of aspects of the transceiver 1135 described with reference to FIG. 11.

Interference mitigation manager 815 may be an example of aspects of the interference mitigation manager 1115 described with reference to FIG. 11. Interference mitigation manager 815 may transmit a first signal using a first set of RF chains that is associated with a radio configured for a first RAT, receive a second signal using a second set of RF chains that is associated with a radio configured for a second RAT, map a physical antenna of each RF chain of the first set of RF chains and a physical antenna of each RF chain of the second set of RF chains to a virtual antenna configuration, and process the second signal using the virtual antenna configuration.

Transmitter 820 may transmit signals generated by other components of the device. In some examples, the transmitter 820 may be collocated with a receiver 810 in a transceiver module. For example, the transmitter 820 may be an example of aspects of the transceiver 1135 described with reference to FIG. 11. The transmitter 820 may include a single antenna, or it may include a set of antennas.

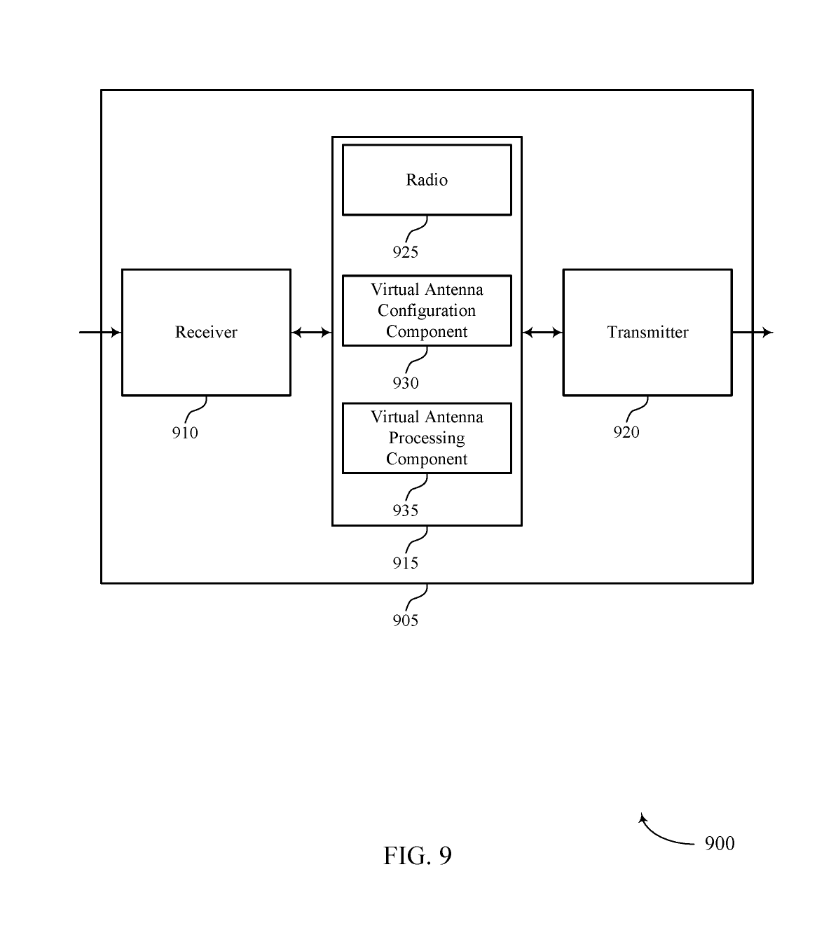

FIG. 9 shows a block diagram 900 of a wireless device 905 that supports interference mitigation with subspace projection in accordance with various aspects of the present disclosure. Wireless device 905 may be an example of aspects of a wireless device 805 or a wireless device 115 as described with reference to FIGS. 1 and 8. Wireless device 905 may include receiver 910, interference mitigation manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to interference mitigation with subspace projection, etc.). Information may be passed on to other components of the device. The receiver 910 may be an example of aspects of the transceiver 1135 described with reference to FIG. 11.

Interference mitigation manager 915 may be an example of aspects of the interference mitigation manager 1115 described with reference to FIG. 11. Interference mitigation manager 915 may also include RF chain manager 925, virtual antenna configuration component 930, and virtual antenna processing component 935.

RF chain manager 925 may transmit a first signal using a first set of RF chains that is associated with a radio configured for a first RAT and receive a second signal using a second set of RF chains that is associated with a radio configured for a second RAT.

Virtual antenna configuration component 930 may map a physical antenna of each RF chain of the first set of RF chains and a physical antenna of each RF chain of the second set of RF chains to a virtual antenna configuration and identify one or more virtual antennas with a weaker interference value than at least one other virtual antenna based on the determined interference channel, where the virtual antenna configuration includes the identified one or more virtual antennas. In some cases, the physical antenna of each RF chain corresponds to a number of receive antennas of a device. Virtual antenna processing component 935 may process the second signal using the virtual antenna configuration.

Transmitter 920 may transmit signals generated by other components of the device. In some examples, the transmitter 920 may be collocated with a receiver 910 in a transceiver module. For example, the transmitter 920 may be an example of aspects of the transceiver 1135 described with reference to FIG. 11. The transmitter 920 may include a single antenna, or it may include a set of antennas.

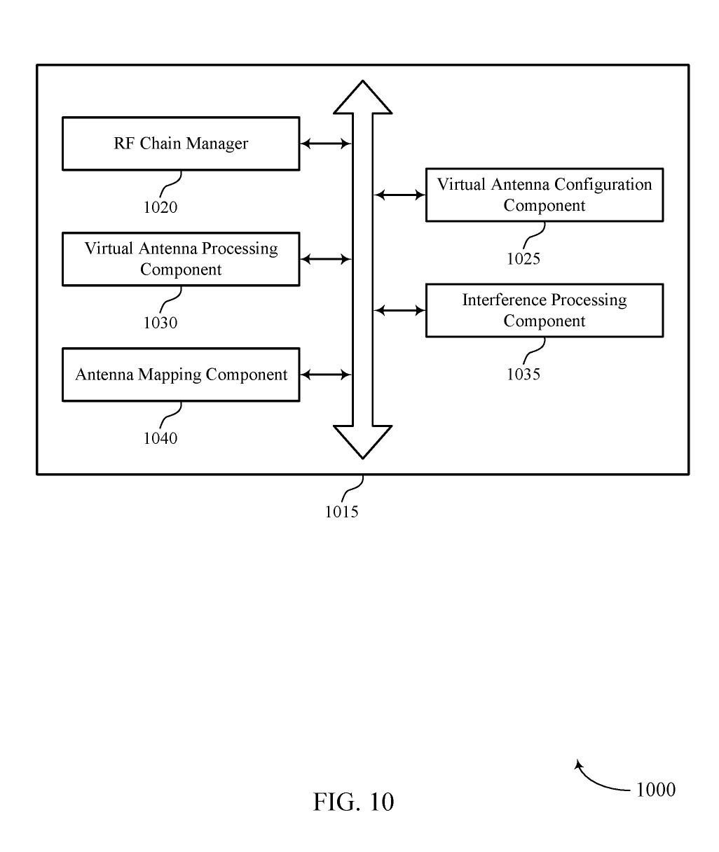

FIG. 10 shows a block diagram 1000 of an interference mitigation manager 1015 that supports interference mitigation with subspace projection in accordance with various aspects of the present disclosure. The interference mitigation manager 1015 may be an example of aspects of an interference mitigation manager 815, an interference mitigation manager 915, or an interference mitigation manager 1115 described with reference to FIGS. 8, 9, and 11. The interference mitigation manager 1015 may include RF chain manager 1020, virtual antenna configuration component 1025, virtual antenna processing component 1030, interference processing component 1035, and antenna mapping component 1040. Each of these modules may communicate, directly or indirectly, with one another (e.g., via one or more buses).

RF chain manager 1020 may transmit a first signal using a first set of RF chains that is associated with a radio configured for a first RAT and receive a second signal using a second set of RF chains that is associated with a radio configured for a second RAT.

Virtual antenna configuration component 1025 may map a physical antenna of each RF chain of the first set of RF chains and a physical antenna of each RF chain of the second set of RF chains to a virtual antenna configuration and identify one or more virtual antennas with a weaker interference value than at least one other virtual antenna based on the determined interference channel, where the virtual antenna configuration includes the identified one or more virtual antennas. In some cases, the physical antenna of each RF chain corresponds to a number of receive antennas of a device. Virtual antenna processing component 1030 may process the second signal using the virtual antenna configuration.

Interference processing component 1035 may determine a SoI associated with the second RAT for each physical antenna of the second set of RF chains and determine an interference channel associated with the physical antenna of each RF chain of the first set of RF chains and the physical antenna of each RF chain of the second set of RF chains, where the mapping is based on the determined SoI and the determined interference channel. In some cases, mapping the physical antenna of each RF chain of the first set of RF chains and the physical antenna of each RF chain of the second set of RF chains to the virtual antenna configuration includes: determining a spatial covariance matrix. In some cases, the spatial covariance matrix is determined during periods of idle mode reception. In some cases, the interference channel is based on interference due to the transmitting according to the first RAT. In some cases, the interference channel is based on interference that includes at least one of duplexer and tuner impedance mismatch, board coupling from a power amplifier, or limited isolation between the physical antennas.

Antenna mapping component 1040 may determine a mapping matrix that is based on an EVD of the spatial covariance matrix, compute values of the mapping matrix based on a set of smallest eigenvalues of the EVD, where identifying the one or more virtual antennas with the weaker interference value is based on the computing, compute values of the mapping matrix based on the interference channel using a Gram-Schmidt orthonormalization procedure, and determine a channel matrix for data demodulation during a channel sounding interval, where the channel matrix for data demodulation is based on the mapping matrix.

FIG. 11 shows a diagram of a system 1100 including a device 1105 that supports interference mitigation with subspace projection in accordance with various aspects of the present disclosure. Device 1105 may be an example of or include the components of wireless device 805, wireless device 905, or a wireless device 115 as described above, e.g., with reference to FIGS. 1, 8 and 9. Device 1105 may include components for bi-directional voice and data communications including components for transmitting and receiving communications, including interference mitigation manager 1115, processor 1120, memory 1125, software 1130, transceiver 1135, antenna 1140, and I/O controller 1145. These components may be in electronic communication via one or more busses (e.g., bus 1110). Device 1105 may communicate wirelessly with one or more APs 105 or base stations 107.

Processor 1120 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting interference mitigation with subspace projection). 1120.

Memory 1125 may include random access memory (RAM) and read only memory (ROM). The memory 1125 may store computer-readable, computer-executable software 1130 including instructions that, when executed by the processor, cause the apparatus to perform various functions described herein. In some cases, the memory 1125 may contain, among other things, a basic input/output system (BIOS) which may control basic hardware and/or software operation such as the interaction with peripheral components or devices.

Software 1130 may include code to implement aspects of the present disclosure, including code to support interference mitigation with subspace projection. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas.

In some cases, the wireless device may include a single antenna 1140. However, in some cases the device may have more than one antenna 1140, which may be capable of concurrently transmitting or receiving multiple wireless transmissions.

I/O controller 1145 may manage input and output signals for device 1105. I/O controller 1145 may also manage peripherals not integrated into device 1105. In some cases, I/O controller 1145 may represent a physical connection or port to an external peripheral. In some cases, I/O controller 1145 may utilize an operating system such as iOS®, ANDROID®, MS-DOS®, MS-WINDOWS®, OS/2®, UNIX®, LINUX®, or another known operating system.

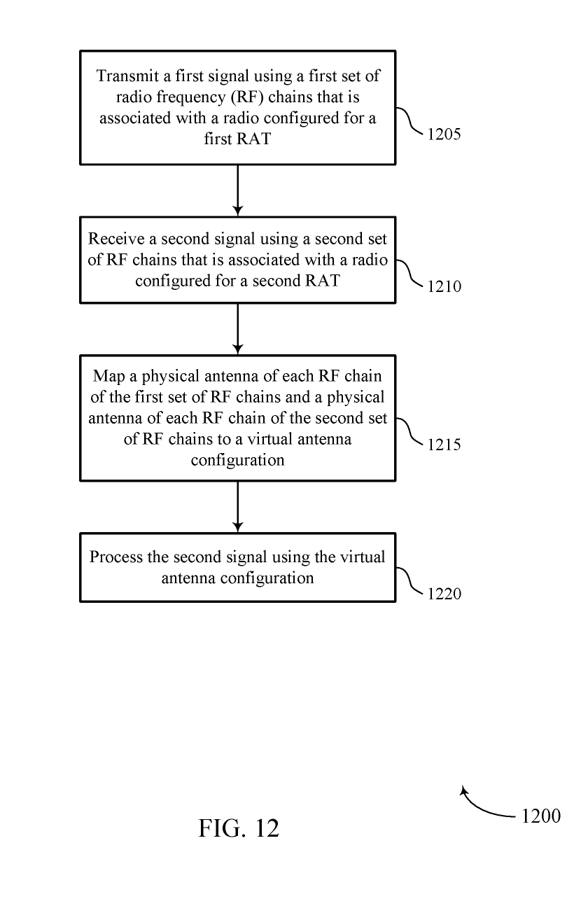

FIG. 12 shows a flowchart illustrating a method 1200 for interference mitigation with subspace projection in accordance with various aspects of the present disclosure. The operations of method 1200 may be implemented by a wireless device 115 or its components as described herein. For example, the operations of method 1200 may be performed by an interference mitigation manager as described with reference to FIGS. 8 through 11. In some examples, a wireless device 115 may execute a set of codes to control the functional elements of the device to perform the functions described below. Additionally or alternatively, the wireless device 115 may perform aspects the functions described below using special-purpose hardware.

At block 1205 the wireless device 115 may transmit a first signal using a first set of RF chains that is associated with a radio configured for a first RAT. The operations of block 1205 may be performed according to the methods described with reference to FIGS. 1 through 6. In certain examples, aspects of the operations of block 1205 may be performed by a RF chain manager as described with reference to FIGS. 8 through 11.

At block 1210 the wireless device 115 may receive a second signal using a second set of RF chains that is associated with a radio configured for a second RAT. The operations of block 1210 may be performed according to the methods described with reference to FIGS. 1 through 6. In certain examples, aspects of the operations of block 1210 may be performed by a RF chain manager as described with reference to FIGS. 8 through 11.

At block 1215 the wireless device 115 may map a physical antenna of each RF chain of the first set of RF chains and a physical antenna of each RF chain of the second set of RF chains to a virtual antenna configuration. The operations of block 1215 may be performed according to the methods described with reference to FIGS. 1 through 6. In certain examples, aspects of the operations of block 1215 may be performed by a virtual antenna configuration component as described with reference to FIGS. 8 through 11.

At block 1220 the wireless device 115 may process the second signal using the virtual antenna configuration. The operations of block 1220 may be performed according to the methods described with reference to FIGS. 1 through 6. In certain examples, aspects of the operations of block 1220 may be performed by a virtual antenna processing component as described with reference to FIGS. 8 through 11.

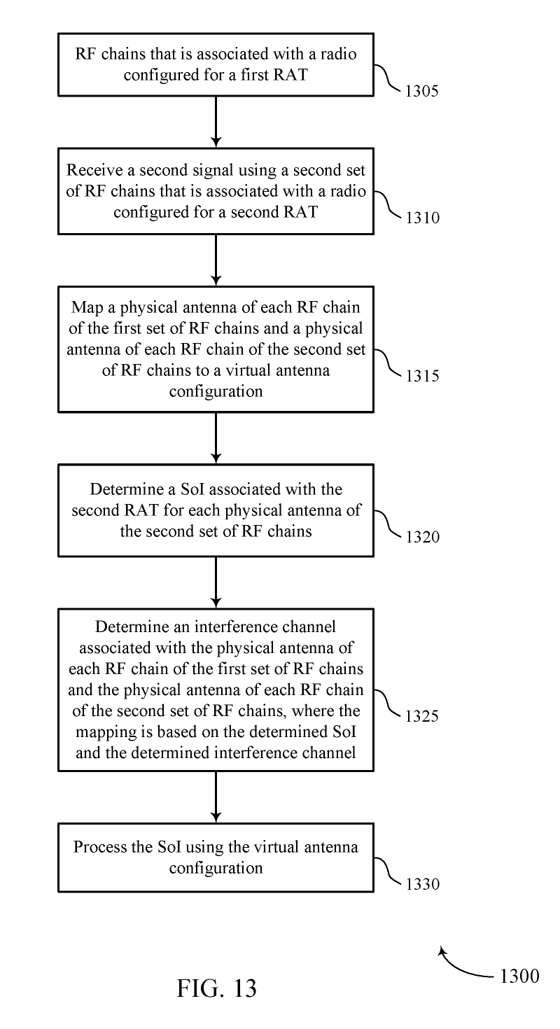

FIG. 13 shows a flowchart illustrating a method 1300 for interference mitigation with subspace projection in accordance with various aspects of the present disclosure. The operations of method 1300 may be implemented by a wireless device 115 or its components as described herein. For example, the operations of method 1300 may be performed by an interference mitigation manager as described with reference to FIGS. 8 through 11. In some examples, a wireless device 115 may execute a set of codes to control the functional elements of the device to perform the functions described below. Additionally or alternatively, the wireless device 115 may perform aspects the functions described below using special-purpose hardware.

At block 1305 the wireless device 115 may transmit a first signal using a first set of RF chains that is associated with a radio configured for a first RAT. The operations of block 1305 may be performed according to the methods described with reference to FIGS. 1 through 6. In certain examples, aspects of the operations of block 1305 may be performed by a RF chain manager as described with reference to FIGS. 8 through 11.

At block 1310 the wireless device 115 may receive a second signal using a second set of RF chains that is associated with a radio configured for a second RAT. The operations of block 1310 may be performed according to the methods described with reference to FIGS. 1 through 6. In certain examples, aspects of the operations of block 1310 may be performed by a RF chain manager as described with reference to FIGS. 8 through 11.

At block 1315 the wireless device 115 may map a physical antenna of each RF chain of the first set of RF chains and a physical antenna of each RF chain of the second set of RF chains to a virtual antenna configuration. The operations of block 1315 may be performed according to the methods described with reference to FIGS. 1 through 6. In certain examples, aspects of the operations of block 1315 may be performed by a virtual antenna configuration component as described with reference to FIGS. 8 through 11.

At block 1320 the wireless device 115 may determine a signal of interest (SoI) associated with the second RAT for each physical antenna of the second set of RF chains. The operations of block 1320 may be performed according to the methods described with reference to FIGS. 1 through 6. In certain examples, aspects of the operations of block 1320 may be performed by an interference processing component as described with reference to FIGS. 8 through 11.

At block 1325 the wireless device 115 may determine an interference channel associated with the physical antenna of each RF chain of the first set of RF chains and the physical antenna of each RF chain of the second set of RF chains, wherein the mapping is based at least in part on the determined SoI and the determined interference channel. The operations of block 1325 may be performed according to the methods described with reference to FIGS. 1 through 6. In certain examples, aspects of the operations of block 1325 may be performed by an interference processing component as described with reference to FIGS. 8 through 11.

At block 1330 the wireless device 115 may process the SoI using the virtual antenna configuration. The operations of block 1330 may be performed according to the methods described with reference to FIGS. 1 through 6. In certain examples, aspects of the operations of block 1330 may be performed by a virtual antenna processing component as described with reference to FIGS. 8 through 11.

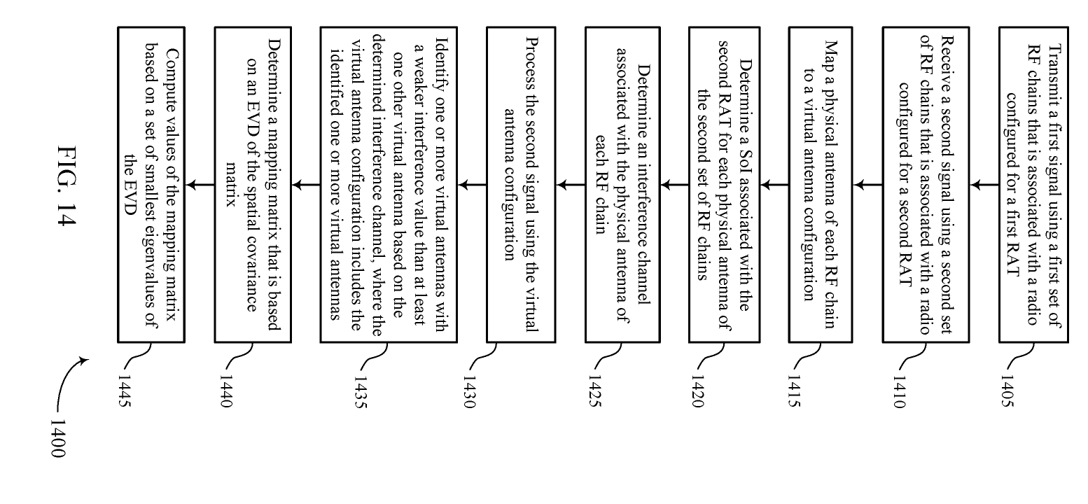

FIG. 14 shows a flowchart illustrating a method 1400 for interference mitigation with subspace projection in accordance with various aspects of the present disclosure. The operations of method 1400 may be implemented by a wireless device 115 or its components as described herein. For example, the operations of method 1400 may be performed by an interference mitigation manager as described with reference to FIGS. 8 through 11. In some examples, a wireless device 115 may execute a set of codes to control the functional elements of the device to perform the functions described below. Additionally or alternatively, the wireless device 115 may perform aspects the functions described below using special-purpose hardware.

At block 1405 the wireless device 115 may transmit a first signal using a first set of radio frequency (RF) chains that is associated with a radio configured for a first radio access technology (RAT). The operations of block 1405 may be performed according to the methods described with reference to FIGS. 1 through 6. In certain examples, aspects of the operations of block 1405 may be performed by a RF chain manager as described with reference to FIGS. 8 through 11.

At block 1410 the wireless device 115 may receive a second signal using a second set of RF chains that is associated with a radio configured for a second RAT. The operations of block 1410 may be performed according to the methods described with reference to FIGS. 1 through 6. In certain examples, aspects of the operations of block 1410 may be performed by a RF chain manager as described with reference to FIGS. 8 through 11.

At block 1415 the wireless device 115 may map a physical antenna of each RF chain of the first set of RF chains and a physical antenna of each RF chain of the second set of RF chains to a virtual antenna configuration. The operations of block 1415 may be performed according to the methods described with reference to FIGS. 1 through 6. In certain examples, aspects of the operations of block 1415 may be performed by a virtual antenna configuration component as described with reference to FIGS. 8 through 11.

At block 1420 the wireless device 115 may determine a signal of interest (SoI) associated with the second RAT for each physical antenna of the second set of RF chains. The operations of block 1420 may be performed according to the methods described with reference to FIGS. 1 through 6. In certain examples, aspects of the operations of block 1420 may be performed by an interference processing component as described with reference to FIGS. 8 through 11.

At block 1425 the wireless device 115 may determine an interference channel associated with the physical antenna of each RF chain of the first set of RF chains and the physical antenna of each RF chain of the second set of RF chains, wherein the mapping is based at least in part on the determined SoI and the determined interference channel. The operations of block 1425 may be performed according to the methods described with reference to FIGS. 1 through 6. In certain examples, aspects of the operations of block 1425 may be performed by an interference processing component as described with reference to FIGS. 8 through 11.

At block 1430 the wireless device 115 may process the second signal using the virtual antenna configuration. The operations of block 1430 may be performed according to the methods described with reference to FIGS. 1 through 6. In certain examples, aspects of the operations of block 1430 may be performed by a virtual antenna processing component as described with reference to FIGS. 8 through 11.

At block 1435 the wireless device 115 may identify one or more virtual antennas with a weaker interference value than at least one other virtual antenna based at least in part on the determined interference channel, wherein the virtual antenna configuration comprises the identified one or more virtual antennas. The operations of block 1435 may be performed according to the methods described with reference to FIGS. 1 through 6. In certain examples, aspects of the operations of block 1435 may be performed by a virtual antenna configuration component as described with reference to FIGS. 8 through 11.

At block 1440 the wireless device 115 may determine a mapping matrix that is based at least in part on an EVD of the spatial covariance matrix. The operations of block 1440 may be performed according to the methods described with reference to FIGS. 1 through 6. In certain examples, aspects of the operations of block 1440 may be performed by an antenna mapping component as described with reference to FIGS. 8 through 11.

At block 1445 the wireless device 115 may compute values of the mapping matrix based at least in part on a set of smallest eigenvalues of the EVD, wherein identifying the one or more virtual antennas with the weaker interference value is based at least in part on the computing. The operations of block 1445 may be performed according to the methods described with reference to FIGS. 1 through 6. In certain examples, aspects of the operations of block 1445 may be performed by an antenna mapping component as described with reference to FIGS. 8 through 11.

In some cases, mapping the physical antenna of each RF chain of the first set of RF chains and the physical antenna of each RF chain of the second set of RF chains to the virtual antenna configuration comprises: determining a spatial covariance matrix.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications network or system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
transmitting a first signal using a first set of radio frequency (RF) chains that is associated with a radio configured for a first radio access technology (RAT);
receiving a second signal using a second set of RF chains that is associated with a radio configured for a second RAT;
mapping a physical antenna of each RF chain of the first set of RF chains and a physical antenna of each RF chain of the second set of RF chains to a virtual antenna configuration; and
processing the second signal using the virtual antenna configuration.

2. The method of claim 1, further comprising:
determining a signal of interest (SoI) associated with the second RAT for each physical antenna of the second set of RF chains; and
determining an interference channel associated with the physical antenna of each RF chain of the first set of RF chains and the physical antenna of each RF chain of the second set of RF chains, wherein the mapping is based at least in part on the determined SoI and the determined interference channel.

3. The method of claim 2, further comprising:
identifying one or more virtual antennas with a weaker interference value than at least one other virtual antenna based at least in part on the determined interference channel, wherein the virtual antenna configuration comprises the identified one or more virtual antennas.

4. The method of claim 3, wherein
mapping the physical antenna of each RF chain of the first set of RF chains and the physical antenna of each RF chain of the second set of RF chains to the virtual antenna configuration comprises: determining a spatial covariance matrix; and
the method further comprising determining a mapping matrix that is based at least in part on an eigenvalue decomposition (EVD) of the spatial covariance matrix.

5. The method of claim 4, further comprising:
computing values of the mapping matrix based at least in part on a set of smallest eigenvalues of the EVD, wherein identifying the one or more virtual antennas with the weaker interference value is based at least in part on the computing.

6. The method of claim 4, further comprising:
computing values of the mapping matrix based at least in part on the interference channel using a Gram-Schmidt orthonormalization procedure.

7. The method of claim 4, wherein
the spatial covariance matrix is determined during periods of idle mode reception.

8. The method of claim 4, further comprising:
determining a channel matrix for data demodulation during a channel sounding interval, wherein the channel matrix for data demodulation is based at least in part on the mapping matrix.

9. The method of claim 2, wherein
the interference channel is based at least in part on interference due to the transmitting according to the first RAT.

10. The method of claim 9, wherein the interference channel is based at least in part on interference that comprises at least one of duplexer and tuner impedance mismatch, board coupling from a power amplifier, or limited isolation between the physical antennas.

11. The method of claim 1, wherein the physical antenna of each RF chain corresponds to a number of receive antennas of a device.

12. An apparatus for wireless communication, comprising:
means for transmitting a first signal using a first set of radio frequency (RF) chains that is associated with a radio configured for a first radio access technology (RAT);
means for receiving a second signal using a second set of RF chains that is associated with a radio configured for a second RAT;
means for mapping a physical antenna of each RF chain of the first set of RF chains and a physical antenna of each RF chain of the second set of RF chains to a virtual antenna configuration; and
means for processing the second signal using the virtual antenna configuration.

13. An apparatus for wireless communication, in a system comprising:
a processor;
memory in electronic communication with the processor; and
instructions stored in the memory and operable, when executed by the processor, to cause the apparatus to:
transmit a first signal using a first set of radio frequency (RF) chains that is associated with a radio configured for a first radio access technology (RAT);
receive a second signal using a second set of RF chains that is associated with a radio configured for a second RAT;
map a physical antenna of each RF chain of the first set of RF chains and a physical antenna of each RF chain of the second set of RF chains to a virtual antenna configuration; and
process the second signal using the virtual antenna configuration.

14. The apparatus of claim 13, wherein the instructions are further executable by the processor to cause the apparatus to:
determine a signal of interest (SoI) associated with the second RAT for each physical antenna of the second set of RF chains;
determine an interference channel associated with the physical antenna of each RF chain of the first set of RF chains and the physical antenna of each RF chain of the second set of RF chains; and
map the physical antenna of each RF chain based at least in part on the determined SoI and the determined interference channel.

15. The apparatus of claim 14, wherein the instructions are further executable by the processor to cause the apparatus to:
identify one or more virtual antennas with a weaker interference value than at least one other virtual antenna based at least in part on the determined interference channel, wherein the virtual antenna configuration comprises the identified one or more virtual antennas.

16. The apparatus of claim 15, wherein the instructions are further executable by the processor to cause the apparatus to:
determine a spatial covariance matrix; and
determine a mapping matrix that is based at least in part on an eigenvalue decomposition (EVD) of the spatial covariance matrix.

17. The apparatus of claim 16, wherein the instructions are further executable by the processor to cause the apparatus to:
compute values of the mapping matrix based at least in part on a set of smallest eigenvalues of the EVD; and
identify the one or more virtual antennas with the weaker interference value is based at least in part on the computing.

18. The apparatus of claim 16, wherein the instructions are further executable by the processor to cause the apparatus to:
determine the spatial covariance matrix during periods of idle mode reception.

19. The apparatus of claim 16, wherein the instructions are further executable by the processor to cause the apparatus to:
determine a channel matrix for data demodulation during a channel sounding interval, wherein the channel matrix for data demodulation is based at least in part on the mapping matrix.

20. The apparatus of claim 13, wherein the physical antenna of each RF chain corresponds to a number of receive antennas of a device.
